(19) United States
(12) Patent Application Publication
(10) Pub. No.: US 2008/0041240 A1
(43) Pub. Date: Feb. 21, 2008

(54) Method and apparatus for removing contaminants from a beverage

(76) Inventor: Elia Rocco Tarantino, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/974,871

(22) Filed: Oct. 16, 2007

Related U.S. Application Data
(63) Continuation-in-part of application No. 11/703,584, filed on Feb. 6, 2007.
(60) Provisional application No. 60/774,435, filed on Feb. 17, 2006.
(60) Provisional application No. 60/855,025, filed on Oct. 27, 2006.

(51) Int. Cl. A23L 2/78; A23L 2/72

(52) U.S. Cl. 99/495

(57) ABSTRACT

Methods and devices of the invention may be utilized to remove or reduce the quantity of one or more contaminants from a foodstuff, and particularly an alcoholic beverage. A contaminant removing material is formed into an object or is associated with an object. The beverage and the object are placed into contact with one another, such as by placing the object in the beverage or pouring the beverage over, through or into the object. The invention has particular applicability to removing or reducing the sulfite content of an alcoholic beverage. The contaminant removing object may be marked with information which identifies the one or more contaminants to be removed. A material may also be introduced to change other properties of the foodstuff, such as the color of a beverage.

### RELATED APPLICATION DATA

This application claims priority to and is a continuation-in-part of U.S. patent application Ser. No. 11/703,584, filed Feb. 6, 2007 which claims priority to U.S. Provisional Application Ser. No. 60/774,435, filed Feb. 17, 2006, and U.S. Provisional Application Ser. No. 60/855,025, filed Oct. 27, 2006.

### FIELD OF THE INVENTION

This invention relates generally to methods for reducing undesired components, such as contaminants, from foodstuffs such as alcoholic beverages.

### RELATED ART

Foodstuffs such as beverages often contain various components which are undesirable. These components may be naturally occurring, may be additives, or may be contaminants. For example, sulfites are added to various foodstuffs including beverages for various reasons, including for stabilizing food colors and acting as preservatives to prevent spoilage due to bacteria and fungi. Sulfites are commonly found in alcoholic beverages such as wines. Wines may include up to about 3 ppm (parts per million) sulfur dioxide produced during yeast metabolism. In addition, during wine production, up to about 30 ppm of sulfites may intentionally be added. Similarly, beer and other alcoholic beverages may contain significant quantities of sulfites and other sulfur derivatives originating from metabolites and due to deliberate addition during production.

Unfortunately, some individuals are highly sensitive to certain foodstuff components such as sulfites. Such individuals may have allergic reactions upon ingesting sulfite containing foods or beverages, ranging from discomfort such as headaches to death in very severe cases.

U.S. government regulations have stringent standards regarding the level of sulfites in consumables. However, there is still a considerable industrial need to continue the use of sulfites as color stabilizers and preservatives. For individuals who are sensitive to sulfites, improved methods for reducing sulfites in alcoholic beverages are highly desirable.

The safety of such individuals would be enhanced, together with their enjoyment of products that are generally available to the public, with a convenient way to remove sulfites. Correspondingly, there is a need for a convenient, easy to use, and cost effective way to remove various contaminants from beverages.

### SUMMARY OF THE INVENTION

The invention comprises methods and apparatus for removing or reducing certain components of foodstuffs. In a preferred embodiment, the methods and devices of the invention may be utilized to remove or reduce the quantity of one or more contaminants from a foodstuff, and particularly an alcoholic beverage.

In accordance with the invention, a component/contaminant removing material is placed into contact with a foodstuff, such as a beverage. The component/contaminant removing material may be formed into an object or be associated with an object. The beverage and the object may be placed into contact with one another, such as by placing the object in the beverage or pouring the beverage over, through or into the object. The object might comprise a stir-stick, caplet, pour spout, decanter or the like.

The invention has particular applicability to removing or reducing the sulfite content of an alcoholic beverage. However, other components/contaminants such as nitrites and histamines may be removed.

In one embodiment of the invention, the component/contaminant removing object is marked with information which identifies the one or more components/contaminants to be removed. A kit of object may be provided, allowing the user to custom select the particular objects necessary for removing desired components/contaminants.

In accordance with yet another aspect of the invention, a material may be introduced to change other properties of the foodstuff, such as the color of a beverage. Such material may also remove one or more components/contaminants.

The foregoing and other articles, features, and advantages of the invention will be apparent from the following more detailed description of the preferred embodiments of the invention. The various features may be utilized or claimed alone or in any combination.

### BRIEF DESCRIPTION OF THE DRAWINGS

FIG. 1A is an isometric view illustrating an exemplary embodiment for a stir-stick of the invention;

FIG. 1B is an isometric view illustrating an alternate embodiment of FIG. 1A, having an alternate color/pattern coding scheme;

FIG. 2A is an isometric view illustrating one embodiment of a filtration caplet for use in filtering a beverage;

FIGS. 2B and 2C are isometric views illustrating alternate embodiments of the filtration caplet of FIG. 2A;

FIG. 3A is an exploded view illustrating an exemplary embodiment of a pouring spout with integral filtration chamber;

FIG. 3B is an assembled view illustrating the pouring spout of FIG. 3A; and

FIG. 3C illustrates the pouring spout of FIG. 3A operatively inserted into an exemplary beverage container.

### DETAILED DESCRIPTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One or more embodiments of the invention comprise methods and apparatus/devices for removing or reducing one or more components of foodstuffs. These components may be contaminants, additives, or naturally occurring substances or elements. The invention has particular applicability to the removal or reduction of sulfites in foodstuffs such as alcoholic beverages.

In the context of this disclosure, the term “sulfites” as used herein includes the salts of sulfurous acids (M₂S₂O₃), acid-sulfites or bisulfites (MHSO₃), sulfur dioxide (SO₂), metabisulfites (M₂S₂O₅), hydrosulfites (M₂S₂O₄), combinations thereof and the like, wherein M represents a cationic counter-ion comprising one or metals or non-metals such as ammonium and derivatives thereof.

The methods and apparatus described herein may reduce the level of one or more components, such as contaminants, in a foodstuff product, such as a beverage. In one embodiment, the method and apparatus may be utilized to reduce the level of sulfites in currently available foodstuff products to substantially lower levels acceptable to individuals who are sensitive to ingestion of sulfites. Of course, the amount of sulfites may be lowered to any pre-determined level, but economic considerations in combination with the needs of allergy-susceptible individuals may favor less stringent methods.

The term “alcoholic beverage” includes any ethanol containing liquid such as wine, beer, whiskey and the like. Though the description provided herein is primarily with reference to alcoholic beverages, the methods and apparatus described herein may also be utilized in conjunction with a variety of foodstuffs other than alcoholic beverages, such as non-alcoholic beverages or other items to be ingested.

In one embodiment of the invention, a component or contaminant removing material is associated with a foodstuff, such as a beverage. As detailed below, one embodiment of the invention is a method by which a component/contaminant is removed from a foodstuff, in which a component/contaminant removing material and the foodstuff are placed in contact with one another. In one embodiment, the component/contaminant removing material is associated with an object or is formed into an object for contact with the foodstuff. Such an object may be referred to herein as a “filter” or “filtration media.”

In a preferred embodiment of the invention, the component/contaminant removing material is a sulfite removing or reducing material which is placed into contact with a sulfite containing foodstuff, such as a beverage. Various embodiments of sulfite removing or reducing materials are described in more detail below. Such materials may have a variety of forms, such as an additive, resin or the like. For example, the material may be a solid or semi-solid resin that is capable of being formed into various shapes and structures. It is contemplated that the resin may be used as a filtration media that facilitates filtering of a fluid.

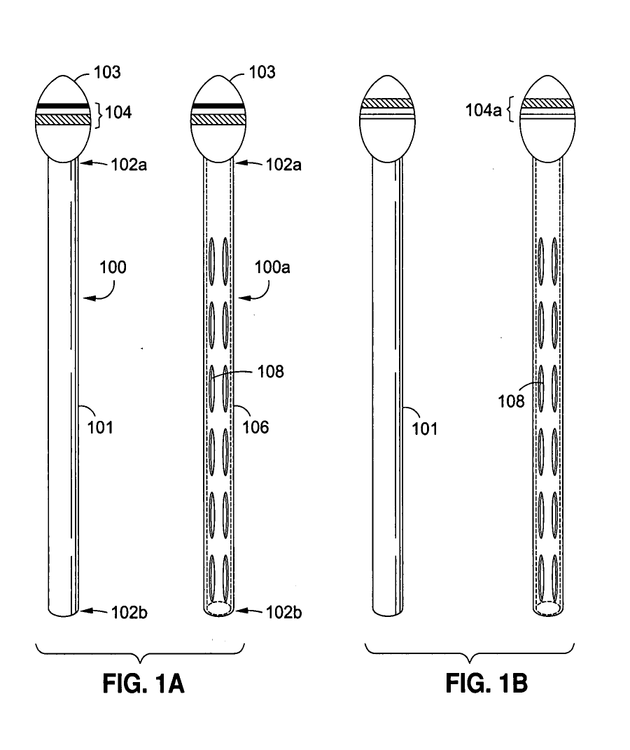

Referring now to FIG. 1A, in accordance with one embodiment of the invention, the component/contaminant removing material may be associated with an object or be formed into an object. The material might also be formed into a filter element, filtration member, filter housing or associated with an item, which may be placed into contact with the foodstuff, such as a beverage. As illustrated, such a filtration media may comprise an ornamental object, such as beverage stirrer or stir-stick 100.

In one embodiment, such as where the material is a resin, the stir-stick may be actually formed of the material. For example, the stir-stick 100 may comprise a rod-like member 101 having a first end 102a and a second end 102b. The stir-stick 100 has a handle 103 extending from or located at the first end 102a, which handle 103 may be used as a grasping portion by the user of the stir-stick. The handle 103 may have a variety of shapes and need not be constructed from the same material as the rod portion of the stir-stick (for example, the rod portion 101 may comprise component/contaminant removing resin material, while the handle may be plastic, glass or the like).

In one embodiment, the component/contaminant removing object may be marked with identifying information. Preferably, the information indicates one or more components/contaminants to be removed. The information may comprise, for example, one or more of text, numbers, colors, shapes or other indicia symbolizing one or more components or contaminants to be removed. In this manner, a user of the object(s) may select the appropriate objects to be used to remove desired components or contaminants. For example, referring to FIG. 1A, the handle 103 of the stir-stick may bear such identification information 104, such as in the form of color coding and/or recognizable patterns. As illustrated, the identification information 104 comprises one or more bands, which bands may also include color or other markings.

In another variation, the stir-stick 100a may comprise a perforated hollow member 106 which is filled with the additive. This embodiment has similar structure as previously discussed with having a first end 102a, a second end 102b, and a handle 103. However, this embodiment has a member 106 that is substantially hollow and is capped/sealed at both ends 102a,b forming a chamber therein. The chamber is used to encapsulate or contain the component/contaminate removing material. The stir-stick 100a has a plurality of fluid passages, openings, or apertures 108 formed in the hollow member 106. The passages 108 are sized to permit the beverage to flow through the passage while retaining the component/contaminant removing material within the hollow member 106. In use, as the stir-stick is moved through the beverage the fluid flows through the passages 108 and contacts the additive encapsulated within the hollow member 106.

FIG. 1B also illustrates another example of identification information 104a. In this embodiment, the information 104 comprises a different combination of bands from the embodiment illustrated in FIG. 1A. In this regard, the various objects for use in removing components/contaminants may be individually marked with identification information identifying the one or more components/contaminants to be removed. Preferably, unique identification information is provided relative to each component/contaminant (or combinations thereof) to be removed. For example, an object configured to remove sulfite may be marked with an “S” or a first combination of bands. An object configured to remove nitrates may be marked with an “N” or a second combination of bands. An object configured to remove both sulfites and nitrites may be marked with “SN” or a third combination of bands.

In one embodiment, a kit may be provided. The kit may comprise a plurality of objects configured to remove one or more different components/contaminants or combinations thereof. For example, the kit may comprise a plurality of stir-sticks comprising component/contaminant removing material or having such material associated therewith. The stir-sticks are preferably marked with identification information as detailed above. In one embodiment, a key may be provided. The key may indicate the particular component(s)/contaminant(s) which are removed by objects in relation to their coding or identification information.

As one example of use of such a kit, a plurality of wine drinkers may be seated at a table. A first party may wish to remove sulfites from their wine. That party may obtain the “sulfite removing” stir-stick by identifying it by its appropriate identification information. A second party may wish to remove nitrites from their wine. That party may obtain the “nitrite removing” stir-stick by identifying it by its appropriate identification information.

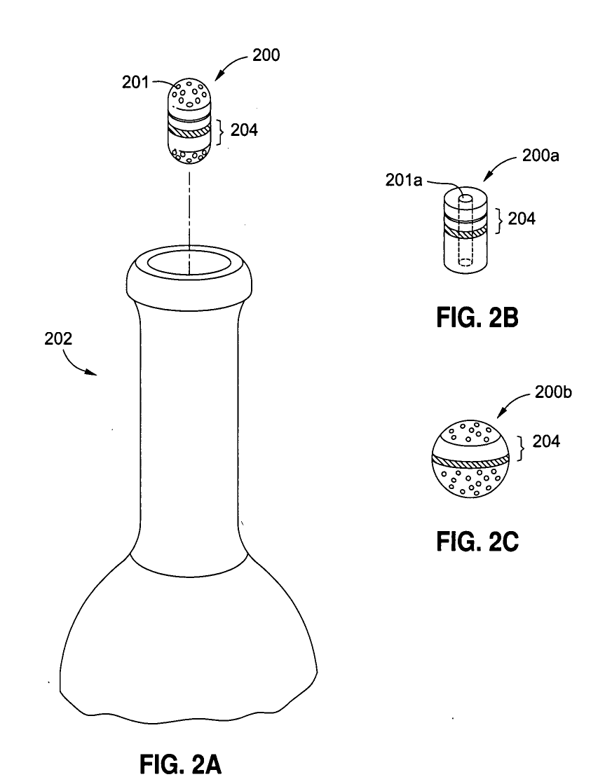

As detailed above, the component/contaminant removing material may be associated with or formed into a variety of other objects. For example, as shown in FIG. 2A, the component/contaminant removing material may be formed into a filter element such as a caplet 200 or a capsule (or other container) so as to provide a specific size or dose of material. The material may be added directly to the desired beverage, such as by dropping the caplet 200 into a container 202 containing the beverage (such as a wine bottle) or into a glass (not shown), which contains (or is to contain) the beverage.

The caplet 200 may be generally a hollow container that is permeable or have a plurality of fluid holes, passages, apertures or orifices 201 formed there through. In this embodiment, the hollow container 200 is filled with the component/contaminant removing/reducing additive. This caplet 200 permits the beverage to flow through the holes and contact the additive therein and thus remove the unwanted contaminants. The holes 201 are sized to retain the material within the caplet 200. It is contemplated and illustrated in FIGS. 2B and 2C that the caplet 200 may be configured in various geometric shapes such as a cylinder 200a, a sphere 200b or other shape capable of insertion into the beverage container 202.

In another variation, the caplet 200 may be entirely formed from the component/contaminant removing material, such as a sulfite removing ion exchange resin. This variation may also have one or more apertures, holes or cavities 201a formed thru the caplet 200 to increase the reactive surface area in contact with the beverage. Additionally the caplet 200 may have an identification information 204 associated therewith. In one embodiment, the identification information may comprise the overall shape or color of the object, such as the shape or color of the caplet 200.

In one embodiment, the component/contaminant removing material may be associated with the packaging of a foodstuff, such as a beverage. For example, one or more caplets or capsules may be placed into a package and be attached to the container containing a beverage. The “dose” of the material may be predetermined for the specific volume of the beverage in the container and/or the component/contaminant content of the beverage. Upon preparing to consume the beverage, a consumer may utilize the associated additive by opening the container and then placing the material into contact with the beverage before its consumption.

The component/contaminant removing material might otherwise be placed into contact with the beverage. For example, a portion of a container (such as a lid or cork or a bottom portion of the container) may comprise one or more component/contaminant removing materials, such as a sulfite removing or reducing additive. Of course, such material(s) may be located in any portion of the container. The material(s) may be located in a portion of the lid is separated by a permeable membrane or may comprise a portion of the lid. In use, an individual might invert the container to assure contact between the container's fluid contents and the component/contaminant removing material prior to consuming the fluid contents. In other embodiments, when a cork or lid of the container is removed, the material may be released into the container into contact with the beverage.

In yet another embodiment, a beverage may be placed into contact with the component/contaminant removing material by transferring the beverage into another container or object. For example, a beverage in a first container may be discharged into one or more intermediary containers configured to reduce component/contaminant levels, and then returned to the first container or another container prior to consumption of the beverage. It is contemplated that the intermediary container or “decanter” has component/contaminant removing material associated therewith, such as including an interior filter media (i.e., an interior surface area fabricated from or including component/contaminant removing material). Correspondingly, when the beverage is poured into the decanter, the beverage comes into contact with the material and the undesired elements within the beverage are entrained in the filter media. The beverage is then either served directly from the decanter or poured into another container for serving.

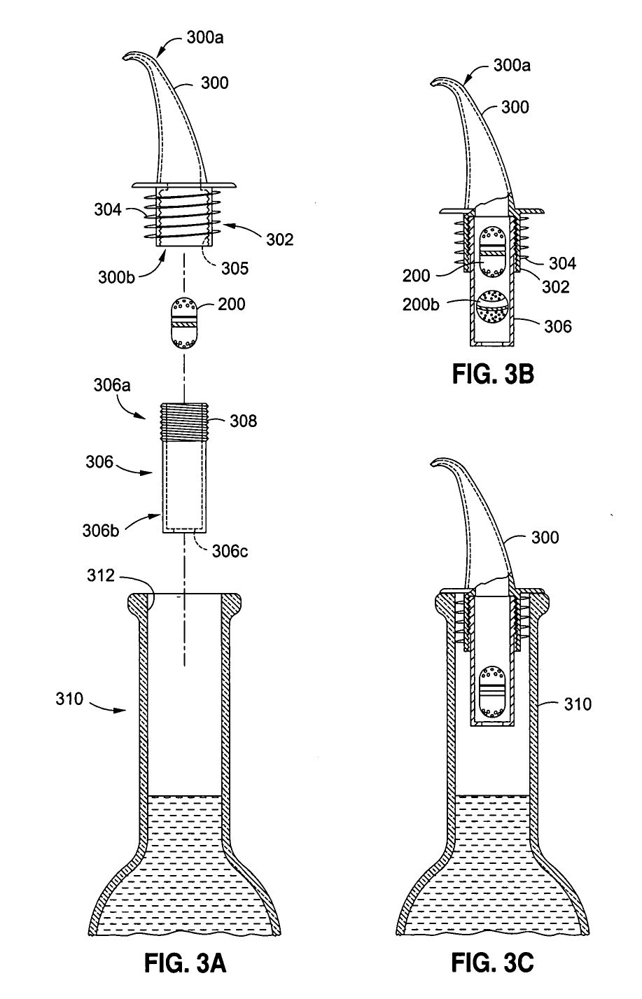

In another embodiment shown in FIG. 3A, the component/contaminant removing material may be formed into or associated with a pouring spout 300 that is removably attached to a beverage container 310 (or other object through which the beverage is poured before consumption). The pouring spout 300 has a stopper 302 which frictionally engages a mating portion or opening 312 in the beverage container 310. The stopper 302 has a plurality of seals 304 which are pliant and conform to the inner surface of the opening 312 provide frictional retention of the pouring spout 300 within the beverage container 310. The pouring spout 300 is fitted with a filter holder 306 which is removably attached to the stopper 302. In use, as the beverage is poured out of the container thru the spout, the fluid comes into contact with the component/contaminant removing material. In another embodiment, the component/contaminant removing material may be formed into the actual spout or be a permeable member associated with the spout. For example, the permeable member may be a mesh-screen made out of the material.

In one embodiment, as illustrated in detail in FIGS. 3A and 3B, the pouring spout 300 may be configured to hold or contain a component/contaminant removing material. In one embodiment, the pouring spout 300 has a first end 300a and a second end 300b. The stopper 302 may be a separate element assembled to the spout or may be integrally formed with the spout. The stopper 302 has a plurality of seals 304 formed there on and are sized for releasable engagement with a beverage container opening 312. The stopper 302 has an opening 305 for releasable engagement and retention of the filter holder 306. The filter holder 306 is configured to retain one or more filtration caplets 200 (discussed above) and has a fluid pathway there through. The filter holder has a first end 306a and a second end 306b. The first end 306a has a mechanical attachment means such as a threaded surface 308 for engaging a corresponding threaded surface of opening 305. It is contemplated that other mechanical attachment means may be used such as a press-fit or snap-fit configuration between the stopper and the filter holder. The second end 306b of the filter holder 306 has a retention boss 306c that prevents the caplets 200 from passing through the second end 306.

In another embodiment, the filter holder 306 (such as a pour spout 300 as illustrated in FIGS. 3A and 3B) is configured to be filled with the component/contaminant removing material such that the filter holder 306 becomes a solid column packed with the material. The first and second ends 306a,b may be fitted with a filter or fine mesh that permits the fluid to flow through the filter holder 306 while also containing the component/contaminant removing material within the filter holder 306. In this variation, the filter holder 306 essentially becomes a solid column of component/contaminant removing material and operatively filters the beverage as it passes through the holder. It is further contemplated that after filtration, the filter holder 306 may be discarded and replaced with a new holder. Conversely, after filtration, the used filter holder may be rejuvenated and reused. Additionally, the filter holder 306 may be filled with one or more component/contaminant removing materials to provide removal of a plurality of contaminants. The filter holder 306 packed with component/contaminant removing material may also be coded as discussed above to provide visual indication of the type of contaminant that is removed with the particular material.

In operation, the pouring spout 300 is prepared for use by inserting the desired filtration caplets 200 or component/contaminant removing material in other form into the filter holder 306 and attaching the filter holder 306 to the spout (as indicated above, the component/contaminant removing material may be packed or filled into the filter holder). The pouring spout 300 is then inserted into the open end 312 of the beverage container 310. As the beverage is dispensed from the container, the beverage flows through an opening in the filter housing and across the filtration caplets. The filtration caplets entrain various contaminants contained in the beverage and prevent user consumption of the contaminants.

It is contemplated that the user may combine various types of component/contaminant removing materials to remove one or more components/contaminants from the beverage. For example, the user may insert a sulfite caplet and a polyphenol caplet into the filter holder to remove/reduce both of these contaminants during the pouring process. Conversely, the user may insert one or more of the same caplet (e.g., two sulfite caplets) to remove/reduce additional amounts of the undesired contaminant.

In an exemplary embodiment, at least a portion of the component/contaminant removing materials may comprise one or more ion exchange resins which are particularly suited to removing sulfites or reducing sulfite levels. By way of example, weakly basic anion exchange resins may include DOWEX™ 66 or DOWEX™ 77 manufactured by The Dow Chemical Company, U.S.A. DOWEX™ 66 and DOWEX™ 77 comprise a styrene DVB (divinyl benzene polymer) macro porous matrix including tertiary amine group functionality. The styrene DVB matrix comprises styrene cross-linked with divinyl benzene. It will be appreciated that the matrix may be any suitable polymer configured with a counter-ion. Weak anion exchange resins may be effective in reducing predominantly acidic sulfites, but not necessarily sulfites in their salt form. When the salt form of sulfites are present, a fluid may initially be de-cationized (that is the metal or non-metal counter-ion may be replaced with an acid group) with a strong acid cation exchange resin such as DOWEX™ 88 followed by treatment with a weakly basic anion exchange resin as discussed above. DOWEX™ 88 comprises a styrene DVB (divinyl benzene polymer) macro porous matrix including sulfonic acid group functionality. Of course any weakly basic and strongly acidic ion exchange resins may be suitably utilized.

In another exemplary embodiment, a strongly basic anion exchange resin such as DOWEX™ 22 may be utilized to reduce sulfites in a beverage. DOWEX™ 22 comprises a styrene DVB (divinyl benzene polymer) macro porous matrix including quaternary amine group functionality. In an embodiment of a DOWEX™ 22 ion exchange resin, the quaternary amine group functionality may be initially exchanged with hydroxyl group. The quaternary amine group may comprise trimethyl ammonium, poly (acrylamido-N-propyltrimethylammonium chloride) or any other suitable quaternary amine. The hydroxyl group of the ion exchange resin may be exchanged for sulfite anions thereby permitting entrainment sulfites in the ion exchange resin when the ion exchange resin contacts the sulfite containing fluid (alcoholic or non-alcoholic beverage). As a result, sulfite anion levels may be substantially reduced in the beverage.

In another embodiment of a DOWEX™ 22 ion exchange resin, the quaternary amine group functionality may be initially exchanged with bicarbonate anion (HCO₃⁻). The bicarbonate group of the ion exchange resin may be exchanged for sulfite anions thereby permitting entrainment sulfites in the ion exchange resin when the ion exchange resin contacts the sulfite containing fluid. Excess bicarbonate remaining in the fluid may degas as carbon dioxide (CO₂), and the fluid may subsequently achieve a slightly acidic pH as is well understood. Since the level of sulfites in most consumable beverages is very low (less than about 30-70 parts per million), an increased acidity of the fluid would be imperceptible in use.

In yet another embodiment, the quaternary amine group functionality of DOWEX™ 22 ion exchange resin may be initially exchanged with carbonate anion (CO₃²⁻). When carbonate group of the ion exchange resin exchanges for sulfite anions thereby entraining sulfites in the ion exchange resin on contact with sulfite containing fluids, any insoluble carbonates may precipitate out, while soluble carbonates will remain in solution. Again, since the level of sulfites in most consumable beverages is very low any precipitates would be imperceptible.

It will be appreciated that any weak acid anion such as bicarbonate, carbonate, acetate, phosphoric, carboxylate and combinations thereof, and the like may exchange out quaternary bases of DOWEX™ 22 ion exchange resins (or any other ion exchange resin having a quaternary base functionality). Furthermore, ion exchange resins may be suitably sized to provide greater contact area and more efficient ion exchange capability.

In accordance with the invention, other materials may be utilized to remove or reduce other components/contaminants. For example, the method and apparatus of the invention may be utilized to remove or reduce nitrites, tannins (polyphenols), histamines or other components/contaminants from a foodstuff, and preferably a beverage such as wine.

In one embodiment, the component/contaminant removing material, such as filtration media, may be rejuvenated or regenerated after one or more uses. In this manner, the material may be reused a number of times before replacement is required. The regeneration process may comprise introducing a solution that removes contaminates absorbed by the material. For example, if the decanter's filter media is configured to remove sulfites from the beverage, once the decanter is empty, a regenerating solution may be placed in the decanter which removes the entrained sulfites from the filter media and prepares the media for another operative filtration cycle.

In accordance with another aspect of the invention, a material may be utilized to change other properties of a foodstuff, and most particularly, a beverage. In one embodiment, the method and apparatus of the invention disclosed herein may be utilized to alter the coloration or appearance of a beverage. In particular, one or more materials may be introduced to the beverage for such purposes. Such materials may also have the benefit of removing one or more components or contaminants. For example, the above-referenced ion exchange resins may be utilized to remove or reduce the red coloration of a red wine.

It is contemplated that various combinations of materials may be utilized in accordance with the invention to produce a specific color change in the beverage. The material may be introduced to the beverage in a variety of ways, such as disclosed above. For example, a user may use a stir-stick, caplet or pouring spout to remove a particular component/contaminant and/or change the color of the beverage. For example, the user may decide to filter a red wine for sulfites and in the process alter the color of the wine from red to a white wine. It is contemplated that the user may customize or control the magnitude of the filtration to produce a beverage that particularly suites the user.

In operation, the invention disclosed herein may be implemented to produce a wine that is reduced with respect to particular contaminants and may also be converted to a different coloration or appearance. Altering the color of the beverage, especially wine, may be useful for both consumption by drinking and various cooking applications. For example, changing the color of wine so that the wine is less likely to cause stains, or altering the color of wine to avoid discoloring a particular recipe. By using the additive or combinations thereof, a user may convert red wine to a white wine or a combination thereof. For example, a user may produce a white Burgundy, a blush Burgundy, a white Merlot, a blush Merlot or an infinite combination of colorations and contaminant filtrations. As the user implements or selects various additives to use in removing contaminants, the coloration of the wine may also be altered to the user's particular preferences. Additionally, the more additive that is used the greater the change in coloration of the beverage. It is contemplated that the user will arrive at a particular filtration/coloration combination that is well suited for the individual tastes of that user. In this way, the method and apparatus disclosed herein provides the user with increased flexibility to customize the taste and appearance of a beverage.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A kit for altering the composition of a beverage comprising:
a first filtration media having at least a first contaminant removing material associated therewith, said first filtration media configured to be placed into contact with said beverage for removing said at least one first contaminant there from, and said first filtration media including first information identifying said at least one first contaminant to be removed; and
at least a second filtration media having at least second contaminant removing material associated therewith, said second filtration media configured to be placed into contact with said beverage for removing said at least one second contaminant there from, and said second filtration media including second information identifying said at least one second contaminant to be removed.

2. The kit in accordance with claim 1 wherein said first contaminant removing material comprises an ion exchange resin, said resin configured with a strongly basic counter-ion to entrain a substantial quantity of at least one contaminant of said beverage and thereby reduce the level of said at least one contaminant within said beverage.

3. The kit in accordance with claim 2 wherein said ion exchange resin is configured to remove at least one sulfite from said beverage.

4. The kit in accordance with claim 2 wherein said ion exchange resin is configured to change a color of said beverage.

5. The kit in accordance with claim 1 wherein said first and second filtration media are configured as a stir-stick.

6. The kit in accordance with claim 1 wherein said first filtration media is formed from said first contaminant removing material and said second filtration media is formed from said second contaminant removing material.

7. The kit in accordance with claim 1 wherein said first contaminant removing material is associated with a first object and said second contaminant removing material is associated with a second object.

8. The kit in accordance with claim 1 wherein said first and second information comprise one or more of text, numbers, colors and markings.

9. The kit in accordance with claim 1 including a key identifying said first and second information relative to said first and second contaminant removing materials.

10. The kit in accordance with claim I wherein said first and second information comprises one or more coded bands.

11. The kit in accordance with claim I wherein said at least one first and at least one second contaminant are selected from the group consisting of: nitrites, sulfites, and histamines.
